(19) United States
(12) Patent Application Publication
(10) Pub. No.: US 2020/0076959 A1
(43) Pub. Date: Mar. 5, 2020

(54) IMAGE READING DEVICE AND IMAGE FORMING APPARATUS

(71) Applicant: KYOCERA Document Solutions Inc., Osaka (JP)

(72) Inventor: Masayoshi TAKAHASHI, Osaka (JP)

(73) Assignee: KYOCERA Document Solutions Inc., Osaka (JP)

(21) Appl. No.: 16/549,224

(22) Filed: Aug. 23, 2019

(30) Foreign Application Priority Data
Aug. 29, 2018 (JP) 2018-160183

(51) Int. Cl. H04N 1/00; H04N 1/028

(52) U.S. Cl. CPC H04N 1/00037; H04N 1/00013; H04N 2201/0094; H04N 1/00074; H04N 1/02815; H04N 1/00063

(57) ABSTRACT

An image reading device includes a light source, a reading portion including an image sensor, an optical member, and a control portion. The image sensor is divided into a first region in which light of the light source is directly received without passing through the optical member and a second region in which light of the light source is received via the optical member. Based on whether a first output value corresponding to an amount of light received in the first region and a second output value corresponding to an amount of light received in the second region are each at a normal level or an abnormal level, the control portion identifies an abnormality.

### INCORPORATION BY REFERENCE

This application is based upon and claims the benefit of priority from the corresponding Japanese Patent Application No. 2018-160183 (filed on Aug. 29, 2018), the contents of which are incorporated herein by reference.

### BACKGROUND

The present disclosure relates to an image reading device and an image forming apparatus.

A conventional image reading device includes a light source and a reading portion. The light source emits light. The light of the light source is applied to an original document as an object to be read. The reading portion optically reads the original document. The reading portion includes an image sensor. The image sensor receives the light of the light source (the light reflected off the original document). Then, the image sensor outputs a value corresponding to an amount of the light received.

Now, as such a conventional image reading device, there is a type that has a function of identifying an occurring abnormality. In a case where image reading quality has been deteriorated, this type of conventional image reading device determines that an abnormality is occurring. Then, the conventional image reading device performs a process of identifying the occurring abnormality (herein, referred to as an inspection process).

The conventional image reading device includes an optical sensor. The optical sensor is installed at such a position as to be able to receive light emitted from the light source.

In performing the inspection process, the conventional image reading device causes light to be emitted from the light source. In a case where the light of the light source has entered the optical sensor, the conventional image reading device determines that an abnormality is occurring in the reading portion. Furthermore, in a case where the light of the light source has not entered the optical sensor, the conventional image reading device determines that an abnormality is occurring in the light source.

### SUMMARY

An image reading device according to a first aspect of the present disclosure includes a light source, a reading portion, an optical member, and a control portion. The light source emits light. The reading portion includes an image sensor that outputs a value corresponding to an amount of light received. The optical member guides light of the light source to the image sensor. The control portion controls the light source and the reading portion and detects an output value of the image sensor. The image sensor is divided into a first region in which light of the light source is directly received without passing through the optical member and a second region in which light of the light source is received via the optical member. Based on whether a first output value that is an output value corresponding to an amount of light received in the first region and a second output value that is an output value corresponding to an amount of light received in the second region are each at a normal level or an abnormal level, the control portion performs an inspection process of identifying an abnormality occurring in the image reading device.

An image forming apparatus according to a second aspect of the present disclosure includes the above-described image reading device.

### BRIEF DESCRIPTION OF THE DRAWINGS

FIG. 1 is a view showing a configuration of a multi-functional peripheral including an image reading device according to one embodiment of the present disclosure.

FIG. 2 is a view showing a configuration of the image reading device according to one embodiment of the present disclosure.

FIG. 3 is a view showing a positional relationship between a light source and an optical sensor installed in the image reading device according to one embodiment of the present disclosure.

FIG. 4 is a view showing the positional relationship between the light source and the optical sensor installed in the image reading device according to one embodiment of the present disclosure.

FIG. 5 is a view showing a configuration and an installation position of a light blocking member installed in the image reading device according to one embodiment of the present disclosure.

FIG. 6 is a flow chart showing a flow of an inspection process performed by a scan control portion of the image reading device according to one embodiment of the present disclosure.

FIG. 7 is a view for explaining the inspection process (a view for explaining a method for identifying an abnormality) performed by the scan control portion of the image reading device according to one embodiment of the present disclosure.

### DETAILED DESCRIPTION

The following describes a multifunctional peripheral having a plurality of types of functions including a scan function, a print function, and so on as an example of an image forming apparatus according to one embodiment of the present disclosure.

<Configuration of Multi-Functional Peripheral>

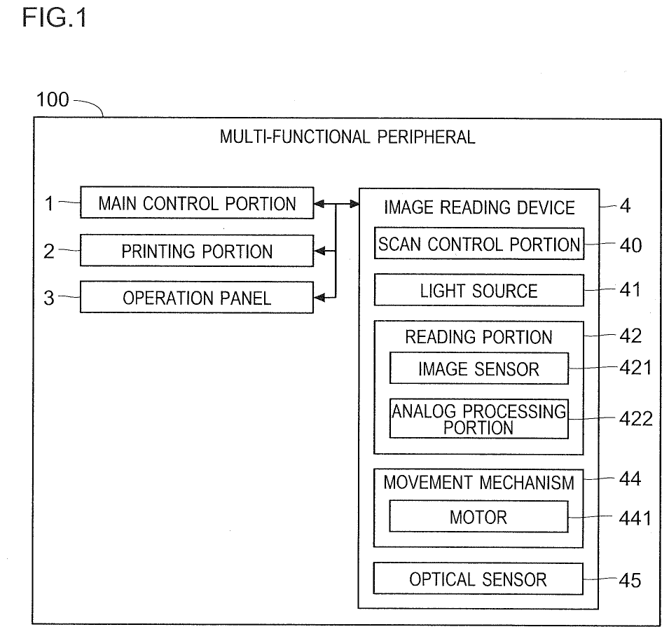

As shown in FIG. 1, a multi-functional peripheral 100 according to this embodiment includes a main control portion 1. The main control portion 1 controls various parts of the multi-functional peripheral 100. The main control portion 1 includes a CPU and a memory. The CPU of the main control portion 1 operates based on a main control program. The memory of the main control portion 1 stores the main control program.

Furthermore, the multi-functional peripheral 100 includes a printing portion 2. The printing portion 2 conveys a sheet. Further, the printing portion 2 prints an image on a sheet being conveyed. The printing portion 2 is controlled by the main control portion 1. As a printing method, the printing portion 2 may adopt an inkjet method or a laser method.

In a case where the printing portion 2 adopts the inkjet method as the printing method, the printing portion 2 is provided with an ink head. The printing portion 2 adopting the inkjet method ejects ink toward a sheet being conveyed so that the ink adheres to the sheet. In a case where the printing portion 2 adopts the laser method as the printing method, the printing portion 2 is provided with a photosensitive drum, a charging device, a developing device, an exposure device, and a transfer roller. The printing portion 2 adopting the laser method develops an electrostatic latent image corresponding to an image to be printed into a toner image and transfers the toner image onto a sheet being conveyed.

Furthermore, the multi-functional peripheral 100 includes an operation panel 3. The operation panel 3 displays a screen. Furthermore, the operation panel 3 accepts an operation from a user. The operation panel 3 is connected to the main control portion 1. The main control portion 1 controls a display operation by the operation panel 3 and detects an operation performed with respect to the operation panel 3.

The operation panel 3 includes a touch screen and a hardware button. The touch screen displays a screen on which software buttons are arranged. A plurality of hardware buttons are provided on the operation panel 3. One example of the hardware button is a start button for accepting an instruction from a user to execute various jobs (including an after-mentioned inspection process) such as a copy job.

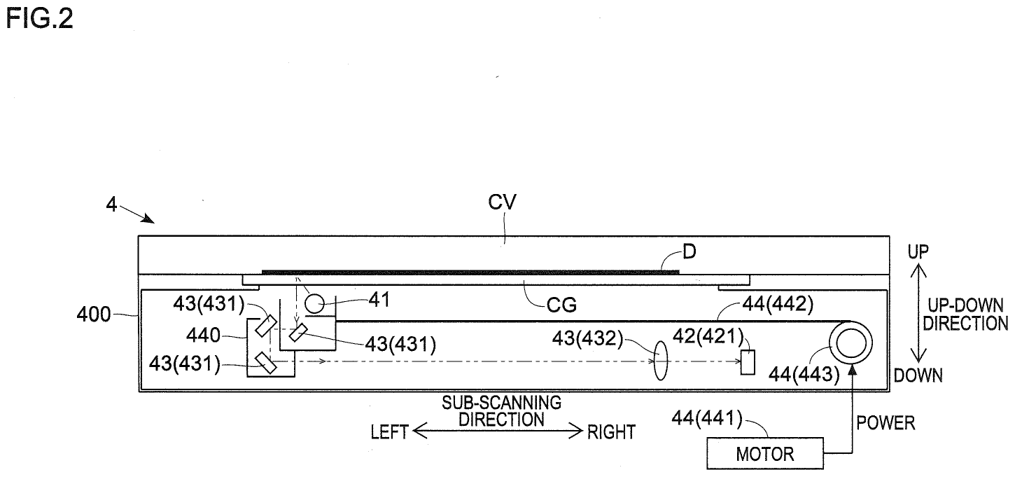

Furthermore, the multi-functional peripheral 100 includes an image reading device 4. The image reading device 4 reads an original document D (see FIG. 2) and generates image data of the original document D. In the copy job, an image based on the image data of the original document D read by the image reading device 4 is printed on a sheet by the printing portion 2. It is also possible to execute a transmission job in which the image data of the original document D is transmitted to an external device, a storage job in which the image data of the original document D is stored in a storage device installed in the multi-functional peripheral 100, and so on.

The image reading device 4 includes a scan control portion 40. The scan control portion 40 corresponds to a “control portion.” The scan control portion 40 controls a reading operation by the image reading device 4. The scan control portion 40 includes a CPU and a memory. The CPU of the scan control portion 40 operates based on a scan control program. The memory of the scan control portion 40 stores the scan control program.

The scan control portion 40 is connected to the main control portion 1. The main control portion 1 gives an operation instruction to the scan control portion 40. Based on the instruction from the main control portion 1, the scan control portion 40 controls the reading operation by the image reading device 4. When the operation panel 3 has accepted, from a user, an instruction to execute a job involving reading of the original document D, the main control portion 1 gives an instruction to read the original document D to the scan control portion 40.

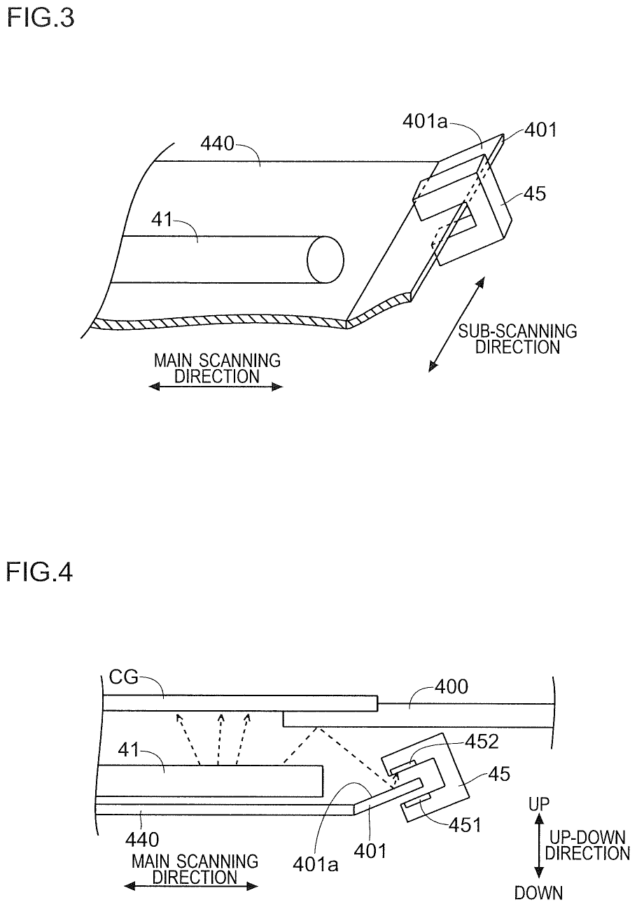

Furthermore, as shown in FIG. 1 to FIG. 4, the image reading device 4 includes a light source 41, a reading portion 42, and an optical member 43. These members of the image reading device 4 are housed in an interior of a housing 400 of the image reading device 4. The housing 400 has an opening formed at an upper part thereof. A contact glass CG is mounted to the opening (the upper part) of the housing 400. The original document D as an object to be read is placed on the contact glass CG.

An original document cover CV is mounted to the housing 400 so as to be pivotable (openable and closable). The original document cover CV is opened and closed with respect to an upper surface of the contact glass CG (a surface on which the original document D is placed). By closing the original document cover CV, the original document D placed on the contact glass CG can be held down by the original document cover CV. When the original document cover CV is closed, a white board (not shown) installed at the original document cover CV is brought to a state of being opposed to the contact glass CG.

The light source 41 emits light. The light source 41 has a plurality of LED elements. The plurality of LED elements are arranged in line in a main scanning direction. The light source 41 may be a fluorescent tube lamp. A part of the light of the light source 41 travels toward the contact glass CG and passes through the contact glass CG. In a case where the original document D is placed on the contact glass CG, the part of the light that has passed through the contact glass CG is reflected off the original document D. Even in a case where the original document D is not placed on the contact glass CG, when the original document cover CV is closed, the part of the light that has passed through the contact glass CG is reflected off the original document cover CV (the white board).

The reading portion 42 optically reads the original document D. The reading portion 42 includes an image sensor 421. The image sensor 421 includes a plurality of photoelectric conversion elements arranged in the main scanning direction. The image sensor 421 receives light from the contact glass CG (light of the light source 41). Light reflected off the original document D or the original document cover CV travels toward the image sensor 421. Upon receipt of the light from the contact glass CG, the image sensor 421 performs photoelectric conversion and stores electric charge for each pixel on a line-by-line basis and outputs a value (an analog signal) corresponding to the electric charge thus stored. That is, the image sensor 421 outputs a value corresponding to an amount of light received.

Furthermore, the reading portion 42 includes an analog processing portion 422. The analog processing portion 422 includes an amplification circuit, an ND conversion circuit, and so on. The analog processing portion 422 amplifies an output value of the image sensor 421 and performs ND conversion of the output value thus amplified.

The light source 41 and the reading portion 42 are connected to the scan control portion 40. The scan control portion 40 controls the light source 41 and the reading portion 42. Furthermore, the scan control portion 40 performs a correction process and so on with respect to image data (an output value of the image sensor 421) obtained through reading of the original document D and transfers the image data thus processed to the main control portion 1.

The optical member 43 guides light of the light source 41 to the reading portion 42 (the image sensor 421). The optical member 43 includes mirrors 431 and a lens 432. The mirrors 431 reflect light from the contact glass CG toward the lens 432. The lens 432 guides the light thus reflected off the mirrors 431 to the image sensor 421. In this manner, light is made to enter the image sensor 421.

Furthermore, the image reading device 4 includes a movement mechanism 44. The movement mechanism 44 is a mechanism for causing a carriage 440 to move in a sub-scanning direction (a direction orthogonal to the main scanning direction). The light source 41 is mounted to the carriage 440. The mirrors 431 of the optical member 43 are also mounted to the carriage 440.

The movement mechanism 44 includes a motor 441. The movement mechanism 44 also includes a wire 442 and a winding drum 443. The wire 442 is connected to the carriage 440 and the winding drum 443. The winding drum 443 rotates by power received from the motor 441. The rotation of the winding drum 443 causes the carriage 440 to move in the sub-scanning direction. That is, the light source 41 moves in the sub-scanning direction.

The movement mechanism 44 (the motor 441) is connected to the scan control portion 40. The scan control portion 40 controls the motor 441 so that the carriage 440 (the light source 41) moves appropriately in the sub-scanning direction. In other words, the scan control portion 40 performs positional control for controlling a position of the carriage 440 (the light source 41) in the sub-scanning direction.

In order for the scan control portion 40 to perform the positional control of the carriage 440, the image reading device 4 includes an optical sensor 45. The optical sensor 45 is, for example, a photointerruptor. The optical sensor 45 includes a light emitting portion 451 and a light receiving portion 452. The optical sensor 45 detects a detection piece 401 as an object to be detected.

The detection piece 401 is placed on the carriage 440. That is, when the carriage 440 (the light source 41) moves in the sub-scanning direction, the detection piece 401 moves in the sub-scanning direction together with the carriage 440. The carriage 440 and the detection piece 401 may be formed integrally with each other.

The detection piece 401 is plate-shaped, having an upper surface and a lower surface. A reflection surface 401a that reflects light is formed on the upper surface of the detection piece 401. Furthermore, the detection piece 401 is inclined in an obliquely upward direction from a carriage 440 side toward an opposite side thereto. The detection piece 401 is inclined in this manner, and thus it becomes easy for light of the light source 41 to enter the reflection surface 401a of the detection piece 401. The light that has thus entered the reflection surface 401a of the detection piece 401 is reflected.

The optical sensor 45 is installed so that the light emitting portion 451 and the light receiving portion 452 are opposed to each other via a movement path of the detection piece 401. The light emitting portion 451 is opposed to the lower surface of the detection piece 401, and the light receiving portion 452 is opposed to the reflection surface 401a (the upper surface) of the detection piece 401.

The optical sensor 45 outputs an output value varying depending on an amount of light received by the light receiving portion 452. In a case where the detection piece 401 is disposed between the light emitting portion 451 and the light receiving portion 452, even when the light emitting portion 451 emits light, the light is blocked by the detection piece 401. Because of this, the light receiving portion 452 receives no light. On the other hand, in a case where the detection piece 401 is not disposed between the light emitting portion 451 and the light receiving portion 452, when the light emitting portion 451 emits light, the light receiving portion 452 receives the light. Accordingly, an output value of the optical sensor 45 varies depending on a position of the carriage 440 (the light source 41) in the sub-scanning direction.

Upon receipt of an instruction to read the original document D from the main control portion 1, based on an output value for positional control outputted from the optical sensor 45, the scan control portion 40 performs the positional control of the carriage 440 (the light source 41). At this time, the scan control portion 40 aligns a position of the carriage 440 (the light source 41) in the sub-scanning direction with a preset reference position. The scan control portion 40 detects, as the output value for positional control, an output value of the optical sensor 45 outputted when the light emitting portion 451 is emitting light.

After having aligned the position of the carriage 440 (the light source 41) in the sub-scanning direction with the reference position, by using the movement mechanism 44, the scan control portion 40 causes the carriage 440 to move to one side (a right side as seen from the front) in the sub-scanning direction. Furthermore, while causing the carriage 440 to move in the sub-scanning direction, the scan control portion 40 performs control so that light is emitted from the light source 41. Then, the scan control portion 40 controls the reading portion 42 to repeatedly perform photoelectric conversion of reflection light from the contact glass CG.

<Inspection Process>

In a case where an abnormality is occurring in the image reading device 4, the original document D cannot be read properly. This results in an inconvenience that image reading quality is deteriorated. Alternatively, this can also lead to an inconvenience that reading itself of the original document D cannot be performed. Accordingly, it would be necessary to ask a maintenance service provider to perform maintenance (such as clearing or replacement of components) of the image reading device 4.

Furthermore, depending on a temperature or a humidity at a location where the multi-functional peripheral 100 is installed, condensation occurs in an interior of the image reading device 4. For example, when condensation occurs on the optical member 43, image reading quality is deteriorated. That is, there is brought about a state where an abnormality is occurring in the image reading device 4.

Even when condensation has occurred on the optical member 43, the condensation on the optical member 43 is removed after a certain period of time. In a case where a fan is installed in the image reading device 4, the condensation on the optical member 43 can be removed by using the fan to provide ventilation. Furthermore, in a case where a heater is installed in the image reading device 4, the condensation on the optical member 43 can be removed through heat generation by the heater.

Accordingly, as for an abnormality in the image reading device 4 caused by condensation on the optical member 43, there is no need for maintenance by a maintenance service provider. It is, however, difficult for a user to determine whether or not an abnormality occurring in the image reading device 4 is caused by condensation on the optical member 43.

To this end, the scan control portion 40 performs an inspection process of identifying an abnormality occurring in the image reading device 4 (an area in which the abnormality is occurring and contents thereof). For example, the scan control portion 40 notifies the main control portion 1 of inspection result information indicating a result of the inspection process. The main control portion 1 recognizes contents of the inspection result information and controls the operation panel 1 to provide notification of the contents thus recognized.

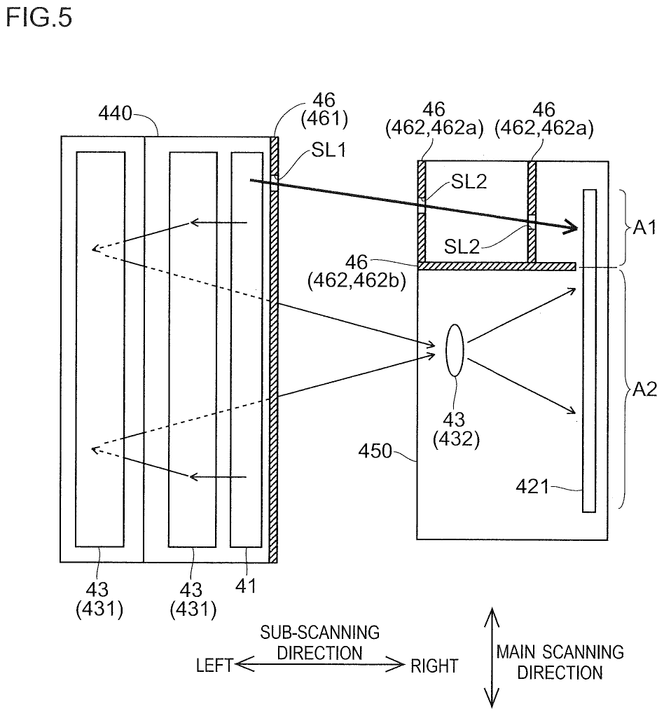

As shown in FIG. 5, in order for the scan control portion 40 to perform the inspection process, the image sensor 421 (the plurality of photoelectric conversion elements) is divided into a first region A1 and a second region A2. The first region A1 of the image sensor 421 is not used for reading of the original document D, and the second region A2 of the image sensor 421 is used for reading of the original document D. Of the plurality of photoelectric conversion elements, photoelectric conversion elements in the first region A1 directly receive light of the light source 41 without the light passing through the optical member 43, and photoelectric conversion elements in the second region A2 receive light of the light source 41 via the optical member 43. In FIG. 5, a thick line arrow indicates light traveling from the light source 41 directly toward the image sensor 421 (the first region A1) without passing through the optical member 43.

Furthermore, a light blocking member 46 is installed in the interior of the housing 400. The light blocking member 46 includes a first light blocking member 461 and a second light blocking member 462. In FIG. 5, the light blocking member 46 is shown by hatching.

The first light blocking member 461 is installed on one side (a right side as seen from the front) of the light source 41. That is, the first light blocking member 461 is installed between the light source 41 and the image sensor 421. The first light blocking member 461 is mounted to the carriage 440. The first light blocking member 461 and the carriage 440 may be formed integrally with each other. The first light blocking member 461 is plate-shaped. The first light blocking member 461 is disposed at such a position as to cover the light source 41 as seen from the one side (the right side) of the light source 41. The first light blocking member 461 has a slit SL1 (a hole). Thus, a part of light of the light source 41 passes through the slit SL1 and travels directly toward the image sensor 421. A remaining part of the light of the light source 41 travels toward the contact glass CG or is reflected off the first light blocking member 461.

The second light blocking member 462 is installed on the other side (a left side as seen from the front) of the image sensor 421. That is, the second light blocking member 462 is installed between the light source 41 and the image sensor 421. The second light blocking member 462 is mounted to a base 450 in which the image sensor 421 and the lens 432 are secured. The second light blocking member 462 includes slit plates 462a. The slit plates 462a have a slit SL2 (a hole), respectively. The slit plates 462a are each disposed at such a position as to cover the first region A1 as seen from the other side (the left side) of the image sensor 421. Furthermore, the second light blocking member 462 includes a partition wall 462b disposed so as to divide the base 450 into a portion on a first region A1 side (a rear side) and a portion on a second region A2 side (a front side).

In a state where the carriage 440 (the light source 41) is at a preset inspection position in the sub-scanning direction, when light of the light source 41 passes through the slit SL1, the light that has thus passed through the slit SL1 travels directly toward the first region A1. Direct light, namely, the light travelling directly toward the first region A1 passes through the slit SL2 and enters the first region A1. On the other hand, indirect light (light other than the direct light), namely, light traveling toward the first region A1 via the optical member 43 is blocked by the slit plates 462a or the partition wall 462b and thus does not enter the first region A1 (does not pass through the slit SL2). FIG. 5 shows a state where the carriage 440 (the light source 41) is at the inspection position.

As shown in FIG. 4, in a state where the carriage 440 (the light source 41) is at the inspection position, when the light source 41 emits light, the light of the light source 41 is reflected off the housing 400 and the reflection surface 401a of the detection piece 401. As a result, the light of the light source 41 enters the light receiving portion 452 of the optical sensor 45. That is, the optical sensor 45 (the light receiving portion 452) is installed at such a position as to be able to receive light emitted from the light source 41 in the state where the carriage 440 is at the inspection position. In FIG. 4, light of the light source 41 is indicated by a broken line arrow.

In performing the inspection process, the scan control portion 40 detects a first output value that is an output value corresponding to an amount of light received in the first region A1 of the image sensor 421 and detects a second output value that is an output value corresponding to an amount of light received in the second region A2 of the image sensor 421. Furthermore, the scan control portion 40 detects a third output value that is an output value corresponding to an amount of light received by the light receiving portion 452 of the optical sensor 45. Then, based on the first output value, the second output value, and the third output value, the scan control portion 40 identifies an abnormality occurring in the image reading device 4.

The operation panel 3 accepts an instruction to execute the inspection process from a user. For example, when accepting an instruction to execute the inspection process, the operation panel 3 displays a guidance screen (not shown) related to the inspection process. On the guidance screen, there is displayed a message prompting to operate the start button in a state where the original document cover CV is closed. Thus, the original document cover CV is closed, and the start button is operated in that state. While the guidance screen is displayed, upon detecting that the start button has been operated in the state where the original document cover CV is closed, the main control portion 1 determines that an instruction to execute the inspection process has been accepted and thus controls the scan control portion 40 to perform the inspection process.

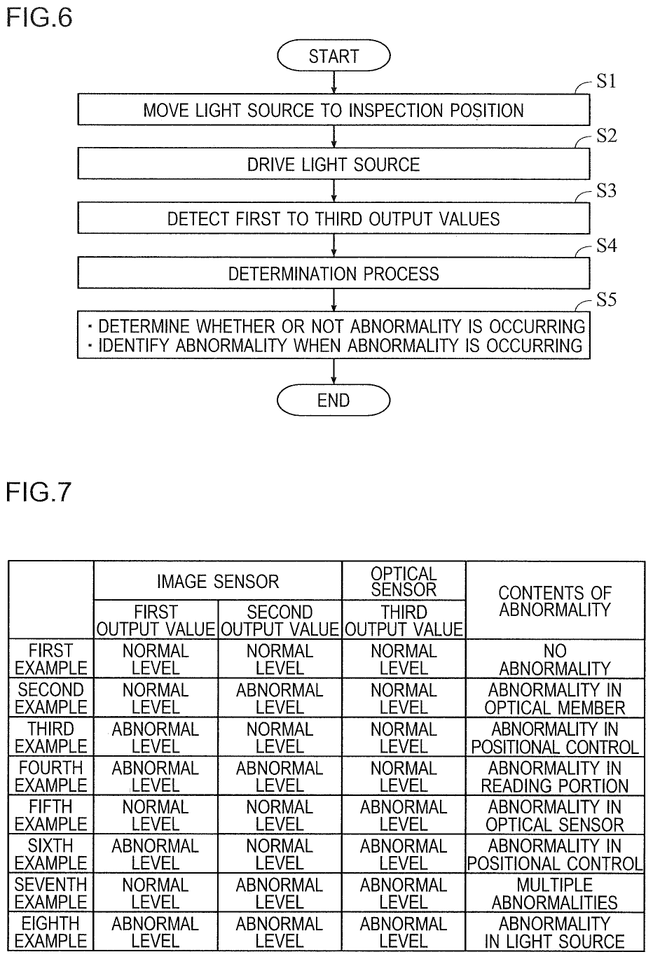

With reference to a flow chart shown in FIG. 6, the following describes a flow of the inspection process performed by the scan control portion 40. The process performed by following the flow chart shown in FIG. 6 starts when the operation panel 3 accepts an instruction to execute the inspection process from a user (when the main control portion 1 instructs the scan control portion 40 to execute the inspection process).

At Step S1, by using the movement mechanism 44, the scan control portion 40 causes the carriage 440 (the light source 41) to move to the inspection position. At this time, based on an output value for positional control outputted from the optical sensor 45, the scan control portion 40 aligns a position of the carriage 440 in the sub-scanning direction with the inspection position. That is, the scan control portion 40 performs the positional control of the carriage 440. After having aligned the position of the carriage 440 in the sub-scanning direction with the inspection position, the scan control portion 40 controls the light emitting portion 451 of the optical sensor 45 to stop emitting light.

At Step S2, in the state where the light source 41 is at the inspection position, the scan control portion 40 controls the light source 41 to be driven. Unless an abnormality is occurring in the light source 41, the light source 41 emits light.

When light is emitted from the light source 41 in the state where the light source 41 is at the inspection position, there is produced light that travels from the light source 41 through the slits SL1 and SL2 of the light blocking member 46 directly toward the image sensor 421 (light traveling directly toward the image sensor 421 without passing through the optical member 43). The light traveling from the light source 41 directly toward the image sensor 421 without passing through the optical member 43 enters the first region A1.

Furthermore, when light is emitted from the light source 41, regardless of whether or not the light source 41 is at the inspection position, there is produced light that is reflected off the mirrors 431, passes through the lens 432, and travels toward the image sensor 421 (light traveling toward the image sensor 421 via the optical member 43). The light traveling from the light source 41 toward the image sensor 421 via the optical member 43 enters the second region A2.

When light is emitted from the light source 41 in the state where the light source 41 is at the inspection position, the light of the light source 41 is reflected off the housing 400 and the reflection surface 401a of the detection piece 401. Thus, the light of the light source 41 also enters the light receiving portion 452 of the optical sensor 45.

After a process step at Step S2, a transition is made to Step S3. Upon the transition to Step S3, the scan control portion 40 detects the first to third output values outputted when light is emitted from the light source 41 in the state where the light source 41 is at the inspection position. For example, the scan control portion 40 detects, as the first output value, an average value of output values of the photoelectric conversion elements in the first region A1. Furthermore, the scan control portion 40 detects, as the second output value, an average value of output values of the photoelectric conversion elements in the second region A2.

Then, at Step S4, the scan control portion 40 performs a determination process of determining whether the first to third output values are each at a normal level or an abnormal level. For the first to third output values, threshold values as criteria of determination are preset and stored in the memory of the scan control portion 40. In performing the determination process, the scan control portion 40 compares each of the first to third output values with a corresponding one of the threshold values and determines whether the each of the first to third output values is at the normal level or the abnormal level.

For example, for the first to third output values, normal state values are determined beforehand, and the threshold values corresponding to the first to third output values are determined based on the normal state values, respectively. For example, when an amount of light received in the first region A1 of the image sensor 421 is smaller by a fixed amount than an amount of light received therein in a normal state, the first output value is not more than a corresponding one of the threshold values and thus is determined to be at the abnormal level. When an amount of light received in the second region A2 of the image sensor 421 is smaller by a fixed amount than an amount of light received therein in the normal state, the second output value is not more than a corresponding one of the threshold values and thus is determined to be at the abnormal level. When an amount of light received by the optical sensor 45 is smaller by a fixed amount than an amount of light received thereby in the normal state, the third output value is not more than a corresponding one of the threshold values and thus is determined to be at the abnormal level.

At Step S5, based on a result of the determination process, the scan control portion 40 determines whether or not an abnormality is occurring in the image reading device 4. Furthermore, in a case where an abnormality is occurring in the image reading device 4, based on a result of the determination process, the scan control portion 40 identifies the abnormality occurring in the image reading device 4.

With reference to first to eighth examples shown in FIG. 7, the following describes a method for identifying an abnormality occurring in the image reading device 4.

First, as in the first example, it is assumed that the first output value, the second output value, and the third output value are all at the normal level. In this case, the scan control portion 40 determines that no abnormality is occurring in the image reading device 4.

Next, as in the second example, it is assumed that the first output value and the third output value are at the normal level and the second output value is at the abnormal level. The first output value and the third output value are at the normal level, and thus it follows that no abnormality is occurring in the light source 41 (the light source 41 is being driven properly). Furthermore, while the second output value is at the abnormal level, the first output value is at the normal level, and thus it follows that no abnormality is occurring in the reading portion 42 including the image sensor 421.

Here, in a case where an abnormality (such as condensation on the optical member 43) is occurring in the optical member 43, it is likely that an amount of light received in the second region A2 of the image sensor 421 is decreased compared with an amount of light received therein in the normal state. Accordingly, it is highly possible that the second output value is at the abnormal level even when no abnormality is occurring in the reading portion 42. Based on this, in a case where the first output value and the third output value are at the normal level and the second output value is at the abnormal level, the scan control portion 40 determines that an abnormality is occurring in the optical member 43.

Next, as in the third example, it is assumed that the first output value is at the abnormal level and the second output value and the third output value are at the normal level. The second output value and the third output value are at the normal level, and thus it follows that no abnormality is occurring in the light source 41. Furthermore, while the first output value is at the abnormal level, the second output value is at the normal level, and thus it follows that no abnormality is occurring in the reading portion 42 including the image sensor 421.

When a position of the light source 41 in the sub-scanning direction deviates somewhat from the inspection position, while an amount of light received in the first region A1 of the image sensor 421 is decreased compared with a case where there is no such deviation, an amount of light received by the light receiving portion 452 of the optical sensor 45 is substantially the same as in the case where there is no such deviation. Consequently, while the first output value is at the abnormal level, the third output value is at the normal level. The position of the light source 41 in the sub-scanning direction deviates somewhat from the inspection position, and thus it follows that the positional control of the carriage 440 (the light source 41) has not been performed properly. Based on this, in a case where the first output value is at the abnormal level and the second output value and the third output value are at the normal level, the scan control portion 40 determines that an abnormality is occurring in the positional control of the carriage 440.

Next, as in the fourth example, it is assumed that the first output value and the second output value are at the abnormal level and the third output value is at the normal level. The third output value is at the normal level, and thus it follows that no abnormality is occurring in the light source 41.

When only the second output value of the first and second output values is at the abnormal level, it is highly possible that an abnormality is occurring in the optical member 43. When, however, the first output value and the second output value are both at the abnormal level, it is highly possible that an abnormality is occurring in the reading portion 42 including the image sensor 421. Based on this, in a case where the first output value and the second output value are at the abnormal level and the third output value is at the normal level, the scan control portion 40 determines that an abnormality is occurring in the reading portion 42 including the image sensor 421.

Next, as in the fifth example, it is assumed that the first output value and the second output value are at the normal level and the third output value is at the abnormal level. The first output value and the second output value are at the normal level, and thus it follows that no abnormality is occurring in the light source 41 and no abnormality is occurring also in the reading portion 42.

The third output value is at the abnormal level even though no abnormality is occurring in the light source 41, and thus it is highly possible that an abnormality is occurring in the optical sensor 45. For example, in a case where the optical sensor 45 has an issue such as faulty installation thereof or a decrease in its sensitivity, it is possible that the third output value is at the abnormal level even when light of the light source 41 enters the optical sensor 45. Based on this, in a case where the first output value and the second output value are at the normal level and the third output value is at the abnormal level, the scan control portion 40 determines that an abnormality is occurring in the optical sensor 45.

Next, as in the sixth example, it is assumed that the first output value and the third output value are at the abnormal level and the second output value is at the normal level. The second output value is at the normal level, and thus it follows that no abnormality is occurring in the light source 41 and no abnormality is occurring also in the reading portion 42.

When a position of the light source 41 in the sub-scanning direction deviates significantly from the inspection position, an amount of light received in the first region A1 of the image sensor 421 is decreased compared with a case where there is no such deviation, and an amount of light received by the light receiving portion 452 of the optical sensor 45 is also decreased compared with the case where there is no such deviation. Consequently, the first output value and the third output value are at the abnormal level. The position of the light source 41 in the sub-scanning direction deviates significantly from the inspection position, and thus it follows that the positional control of the carriage 440 (the light source 41) has not been performed properly. Based on this, in a case where the first output value and the third output value are at the abnormal level and the second output value is at the normal level, the scan control portion 40 determines that an abnormality is occurring in the positional control of the carriage 440.

Next, as in the seventh example, it is assumed that the first output value is at the normal level and the second output value and the third output value are at the abnormal level. In this case, the scan control portion 40 determines that abnormalities are occurring in two or more among the reading portion 42, the optical member 43, the optical sensor 45, and the positional control of the carriage 440 (multiple abnormalities are occurring).

Next, as in the eighth example, it is assumed that the first output value, the second output value, and the third output value are all at the abnormal level. The first output value, the second output value, and the third output value are all at the abnormal level, and thus it follows that the light source 41 is not being driven properly (the light source 41 is not emitting light). Thus, in a case where the first output value, the second output value, and the third output value are all at the abnormal level, the scan control portion 40 determines that an abnormality is occurring in the light source 41.

In a configuration according to this embodiment, as described above, the image sensor 421 is divided into the first region A1 and the second region A2. In the first region A1, light of the light source 41 is received without passing through the optical member 43. In the second region A2, light of the light source 41 is received via the optical member 43. Based on whether the first output value (an output value corresponding to an amount of light received in the first region A1) and the second output value (an output value corresponding to an amount of light received in the second region A2) are each at the normal level or the abnormal level, the scan control portion 40 performs the inspection process of identifying an abnormality occurring in the image reading device 4. Thus, in a case where image reading quality has been deteriorated, it is possible to identify in which of the light source 41, the reading portion 42, and the optical member 43 an abnormality is occurring. That is, it is possible to specifically identify an abnormality occurring in the image reading device 4.

Furthermore, as described above, the image reading device 4 according to this embodiment includes the light blocking member 46. In a state where the light source 41 is at the preset inspection position in the sub-scanning direction, while allowing direct light to pass therethrough, the light blocking member 46 blocks indirect light from traveling to the first region A1. The direct light is light traveling from the light source 41 directly toward the first region A1 without passing through the optical member 43, and the indirect light is light other than the direct light (light traveling from the light source 41 toward the first region A1 via the optical member 43 or light reflected off the housing 400). In performing the inspection process, based on the first output value and the second output value outputted when light is emitted from the light source 41 in the state where the light source 41 is at the inspection position, the scan control portion 40 identifies an abnormality occurring in the image reading device 4. With this configuration, only direct light traveling from the light source 41 directly toward the first region A1 without passing through the optical member 43 can be made to enter the first region A1. Thus, it is possible to suppress the occurrence of an inconvenience that a result of the inspection process is inaccurate due to light entering the first region A1 from the light source 41 via the optical member 43.

Furthermore, as described above, the image reading device 4 according to this embodiment includes the movement mechanism 44 that causes the light source 41 to move in the sub-scanning direction, the detection piece 401 that moves in the sub-scanning direction together with the light source 41, and the optical sensor 45 that includes the light emitting portion 451 and the light receiving portion 452 and is installed so that the light emitting portion 451 and the light receiving portion 452 are opposed to each other via the movement path of the detection piece 401. Based on an output value for positional control outputted from the optical sensor 45 when the light emitting portion 451 emits light, the scan control portion 40 performs the positional control for controlling a position of the light source 41 in the sub-scanning direction. In performing the inspection process, by using the movement mechanism 44, the scan control portion 40 causes the light source 41 to move to the inspection position and performs control so that light is emitted from the light source 41 in a state where the light source 41 is at the inspection position. With this configuration, it is easily possible to make direct light enter the first region A1, while suppressing entry of indirect light into the first region A1.

Furthermore, in the configuration according to this embodiment, as described above, the optical sensor 45 is installed at such a position as to be able to receive light emitted from the light source 41 in a state where the light source 41 is at the inspection position. In performing the inspection process, based not only on whether the first output value and the second output value are each at the normal level or the abnormal level but also on whether the third output value (an output value of the optical sensor 45 detected without light emission by the light emitting portion 451) is at the normal level or the abnormal level, the scan control portion 40 identifies an abnormality occurring in the image reading device 4. Thus, it is possible to identify whether or not an abnormality is occurring in the optical sensor 45 and to identify whether or not an abnormality is occurring in the positional control of the carriage 440. That is, it is possible to more specifically identify an abnormality occurring in the image reading device 4.

The embodiment disclosed herein is to be construed in all respects as illustrative and not limiting. The scope of the present disclosure is indicated by the appended claims rather than by the foregoing description of the embodiment, and all changes that come within the meaning and range of equivalency of the claims are intended to be embraced therein.

What is claimed is:

1. An image reading device, comprising:
a light source that emits light;
a reading portion that includes an image sensor configured to output a value corresponding to an amount of light received;
an optical member that guides light of the light source to the image sensor; and
a control portion that controls the light source and the reading portion and detects an output value of the image sensor,
wherein
the image sensor is divided into a first region in which light of the light source is directly received without passing through the optical member and a second region in which light of the light source is received via the optical member, and
based on whether a first output value that is an output value corresponding to an amount of light received in the first region and a second output value that is an output value corresponding to an amount of light received in the second region are each at a normal level or an abnormal level, the control portion performs an inspection process of identifying an abnormality occurring in the image reading device.

2. The image reading device according to claim 1, further comprising:
a light blocking member that, in a state where the light source is at a preset inspection position in a sub-scanning direction, while allowing direct light to pass therethrough, the direct light traveling from the light source directly toward the first region without passing through the optical member, blocks indirect light other than the direct light from traveling to the first region,
wherein in performing the inspection process, based on the first output value and the second output value outputted when light is emitted from the light source in the state where the light source is at the inspection position, the control portion identifies an abnormality occurring in the image reading device.

3. The image reading device according to claim 2, further comprising:
a movement mechanism that causes the light source to move in the sub-scanning direction;
a detection piece that moves in the sub-scanning direction together with the light source; and
an optical sensor that includes a light emitting portion and a light receiving portion and is installed so that the light emitting portion and the light receiving portion are opposed to each other via a movement path of the detection piece,
wherein based on an output value for positional control outputted from the optical sensor when the light emitting portion emits light, the control portion performs positional control for controlling a position of the light source in the sub-scanning direction, and
in performing the inspection process, by using the movement mechanism, the control portion causes the light source to move to the inspection position and performs control so that light is emitted from the light source in the state where the light source is at the inspection position.

4. The image reading device according to claim 3, wherein
the optical sensor is installed at such a position as to be able to receive light emitted from the light source in the state where the light source is at the inspection position, and
in performing the inspection process, based not only on whether the first output value and the second output value are each at the normal level or the abnormal level but also on whether a third output value that is an output value of the optical sensor detected without light emission by the light emitting portion is at the normal level or the abnormal level, the control portion identifies an abnormality occurring in the image reading device.

5. The image reading device according to claim 4, wherein
when the first output value, the second output value, and the third output value are at the normal level, the control portion determines that no abnormality is occurring in the image reading device.

6. The image reading device according to claim 4, wherein
when the first output value and the third output value are at the normal level and the second output value is at the abnormal level, the control portion determines that an abnormality is occurring in the optical member.

7. The image reading device according to claim 4, wherein
when the first output value is at the abnormal level and the second output value is at the normal level, the control portion determines that an abnormality is occurring in the positional control.

8. The image reading device according to claim 4, wherein
when the first output value and the second output value are at the abnormal level and the third output value is at the normal level, the control portion determines that an abnormality is occurring in the reading portion.

9. The image reading device according to claim 4, wherein
when the first output value and the second output value are at the normal level and the third output value is at the abnormal level, the control portion determines that an abnormality is occurring in the optical sensor.

10. The image reading device according to claim 4, wherein
when the first output value is at the normal level and the second output value and the third output value are at the abnormal level, the control portion determines that abnormalities are occurring in two or more among the reading portion, the optical member, the optical sensor, and the positional control.

11. The image reading device according to claim 4, wherein
when the first output value, the second output value, and the third output value are at the abnormal level, the control portion determines that an abnormality is occurring in the light source.

12. An image forming apparatus comprising the image reading device according to claim 1.
